(19) United States
(12) Patent Application Publication
(10) Pub. No.: US 2016/0109953 A1
(43) Pub. Date: Apr. 21, 2016

(54) Holographic Wristband

(71) Applicant: Chetan Desh, Bellevue, WA (US)

(72) Inventor: Chetan Desh, Bellevue, WA (US)

(21) Appl. No.: 14/713,766

(22) Filed: May 15, 2015

Related U.S. Application Data
(60) Provisional application No. 62/065,502, filed on Oct. 17, 2014.

(51) Int. Cl. G06F 3/01; G09G 3/00; A44C 5/00

(52) U.S. Cl. CPC G06F 3/017; A44C 5/0007; G06F 3/011; G09G 3/003

(57) ABSTRACT

Disclosed is, among other things, a holographic wristband. It may comprise a wristband configured to emit two-dimensional (2D) or three-dimensional (3D) images. A holographic wristband may utilize lights or lasers to project images such as a virtual keyboard or an interactive holographic map. Sensors may be included to detect, receive, and analyze images, movements, and other data. The holographic wristband may comprise a light-emitting diode (LED) or e-ink touch-sensitive screen which may display images, icons, and other data. A holographic wristband may function as a watch, phone, or computer, for example, and may have capabilities such as Wi-Fi, WiDi, near-field communications (NFC), and Bluetooth.

### FIELD

This disclosure relates generally to a Holographic Wristband.

### BACKGROUND

In this digital age, people often want technology close at hand. Many mobile devices offer limited functionality to keep the technology compact. It is burdensome, however, for people to carry around multiple devices and accessories. Many mobile devices also compromise fashion for functionality, prompting people to give up aesthetically attractive jewelry pieces for modern devices that lack craftsmanship and character.

### SUMMARY

The instant application discloses, among other things, a Holographic Wristband. According to one embodiment, it may comprise a wristband configured to emit two-dimensional (2D) or three-dimensional (3D) images. For example, a Holographic Wristband may project an image of a virtual keyboard or an interactive holographic display. Holographic Wristband may also include sensors for detecting, receiving, and analyzing images, movements, three-dimensional data, and other data. The strap of Holographic Wristband may comprise, for example, a flexible touch-sensitive screen or may display images, icons, and other data. Holographic Wristband may function as a watch, phone, music player, or computer, for example, and may have capabilities such as Wi-Fi, wireless display, for example WiDi or another Miracast-supported technology, near-field communications (NFC), cellular communications, and Bluetooth. Holographic Wristband may provide computer applications such as calendars, email, maps, navigation, music players, health monitors, cameras, and microphones, for example. A person skilled in the art will understand that Holographic Wristband may be made in any material, color, shape, and size.

### BRIEF DESCRIPTION OF THE DRAWINGS

FIG. 1 illustrates a front view of Holographic Wristband according to one embodiment.

FIG. 2 illustrates a perspective view of Holographic Wristband according to one embodiment.

FIG. 3 illustrates a perspective view of Holographic Wristband according to another embodiment.

FIG. 4 illustrates a view of Holographic Wristband projecting a virtual keyboard, according to one embodiment.

FIG. 5 illustrates a view of Holographic Wristband projecting a holographic image, according to one embodiment.

FIG. 6 illustrates a view of Holographic Wristband functioning with a companion device, according to one embodiment.

FIG. 7 is a block diagram illustrating an example of a system capable of supporting a Holographic Wristband method, according to one embodiment.

FIG. 8 is a component diagram of a computing device to which a Holographic Wristband process may be applied according to one embodiment.

Like reference numerals are used to designate like parts in the accompanying drawings.

### DETAILED DESCRIPTION

A more particular description of certain embodiments of Holographic Wristband may be had by references to the embodiments described below, and those shown in the drawings that form a part of this specification, in which like numerals represent like objects.

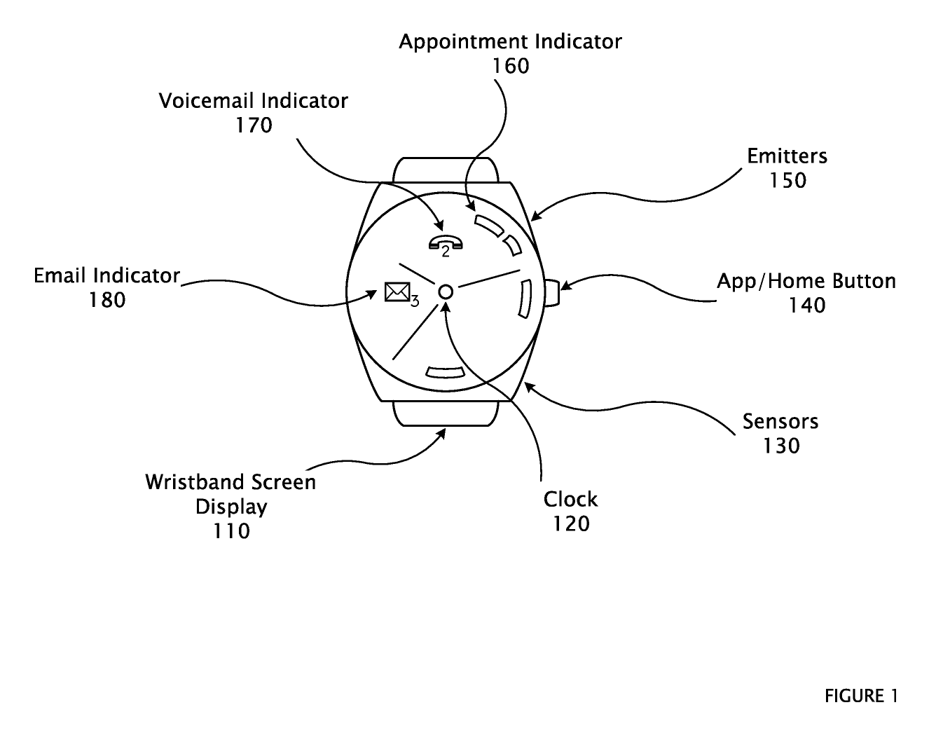

FIG. 1 illustrates a front view of Holographic Wristband according to one embodiment. In this example, Holographic Wristband may comprise a watch with a strap having a wrap-around Wristband Screen Display 110. Wristband Screen Display 110 may be a flexible, touch-sensitive LED screen capable of displaying images, icons, and other data. Holographic Wristband may include a Clock 120 with second, minute, and hour indicators. Clock 120 may include a watch face that resembles a traditional or fashionable watch or jewelry piece, for example. Clock 120 may also have a digital watch face or both digital and analog components. In another embodiment, the display may fit into a width of Wristband Screen Display 110, without a wider face portion.

Holographic Wristband may include Sensors 130 for detecting, receiving, and analyzing images, movements, and other data. For example, Sensors 130 may receive data points when a user types on a virtual keyboard or scrolls through an interactive holographic map. Detected activity may be on a surface or may be in a spatial range. Sensors 130 may also receive data relating to health and environmental conditions. For example, Sensors 130 may comprise haptic sensors to monitor heartbeats, optic sensors to monitor blood oxygen levels, pressure sensors to track blood pressure, vibration sensors to track movement, thermal sensors to take temperature, or moisture sensors to gauge perspiration. Sensors 130 may detect location, distance, acceleration, or orientation, or function as cameras, microphones, or barcode scanners, for example. Sensors 130 may be located anywhere on Holographic Wristband or its components and may communicate data collected with Holographic Wristband or any other device.

Sensors 130 may work in conjunction with Computing Device 810, for example, to provide warnings of potential health issues. For example, if a user's blood pressure changes quickly, Holographic Wristband may provide an audio, visual, or haptic alarm for the user or someone nearby, or may communicate via a network to warn a remote party. One having skill in the art will recognize that many types of events may be tracked and that many types of warnings may be provided.

Holographic Wristband may include Emitters 150 to project 2D images, 3D images, or sounds, for example. According to one embodiment, Emitters 150 may utilize lights or lasers to project a 2D image of a document or virtual keyboard, or a 2D image or 3D holographic image of an interactive map, person, or thing, for example. Emitters 150 may also function as speakers to transmit sounds or vibrations, for example.

Holographic Wristband may also include an App/Home Button 140 to direct a user to a menu or computer applications, for example. Appointment Indicator 160, Voicemail Indicator 170, and Email Indicator 180 may display icons or other images notifying a user of past, present, or future appointment, voice messages, or email, text, or SMS messages, for example.

Holographic Wristband may function as a watch, phone, or computer, for example, and may have capabilities such as Wi-Fi, wireless display, near-field communications (NFC), cellular communications, and Bluetooth. Holographic Wristband may communicate with built-in or third-party computer applications such as calendars, email, maps, navigation, games, cameras, and microphones, for example.

Holographic Wristband may be battery-powered, solar-powered, super-capacitor powered, or may use any other power source such as an electrical outlet. It may also be configured for wireless charging. A person skilled in the art will understand that Holographic Wristband may be made in any material, color, shape, and size. For example, it may be made of a waterproof, scratch-resistant, or heat-resistant material. Holographic Wristband may also have any enclosure means.

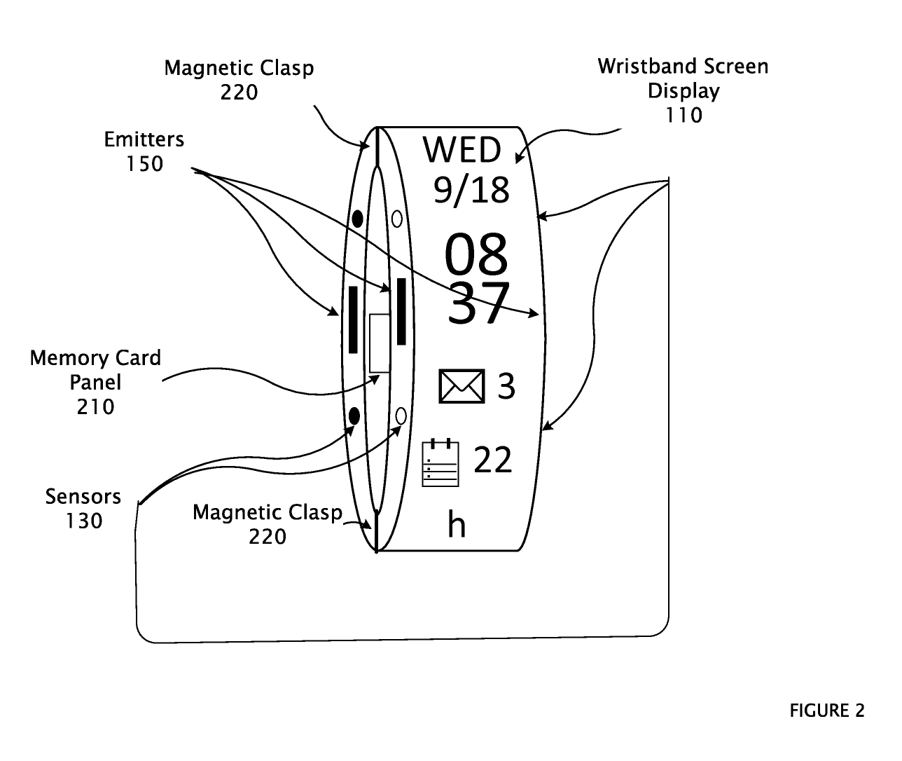

FIG. 2 illustrates a perspective view of Holographic Wristband according to another embodiment. In this example, Wristband Screen Display 110 may display touch-sensitive icons and data such as a current day, date, time, or icons indicating the number of unread or flagged email messages, or appointment alerts, for example. It may also include an icon to turn holographic projection on or off. Wristband Screen Display 110 may comprise a touch-sensitive wrap-around flexible LED screen. A user may swipe the Wristband Screen Display 110 in any direction to view various images and data.

Sensors 130 may detect, receive, and analyze data such as images, movements, health and environmental conditions, and other data, and may communicate that data with Holographic Wristband or any other device. For example, Sensors 130 may receive data points when a user types on a virtual keyboard or interacts with an interactive holographic display projected by Holographic Wristband. Sensors 130 may also be configured to determine the orientation of a Holographic Wristband unit in three dimensions and adjust images and data to be displayed in an upright position on Wristband Screen Display 110. For example, if Holographic Wristband is turned upside-down, the images and data on Wristband Screen Display 110 may also be turned upside-down to give to allow a user to view the information properly.

Emitters 150 may comprise a projection display, and may project any 2D images, 3D images, and sounds, for example, holographic images. Emitters 150 may be located on the inner or outer lateral edges Holographic Wristband, to allow a user's hand to serve as the foreground for the projected images. Emitters 150 may also be located on the upper or lower surface of Wristband Screen Display, or any other location to allow display information above the user's hand, arm, or wrist. Memory Card Panel 210 may receive any type of data storage device.

In another embodiment, Holographic Wristband may use a virtual retinal display technology, projecting an image directly onto a retina of a user's eye. A virtual retinal display may be mounted, for example, on glasses or a hat.

In one embodiment, Holographic Wristband may be held on a user's wrist using Magnetic Clasps 220. In another embodiment, a hinge and a Magnetic Clasp may allow a user to put on or remove the Holographic Wristband. One having skill in the art will recognize that various forms of fasteners may be used to allow physical opening and closing of Holographic Wristband.

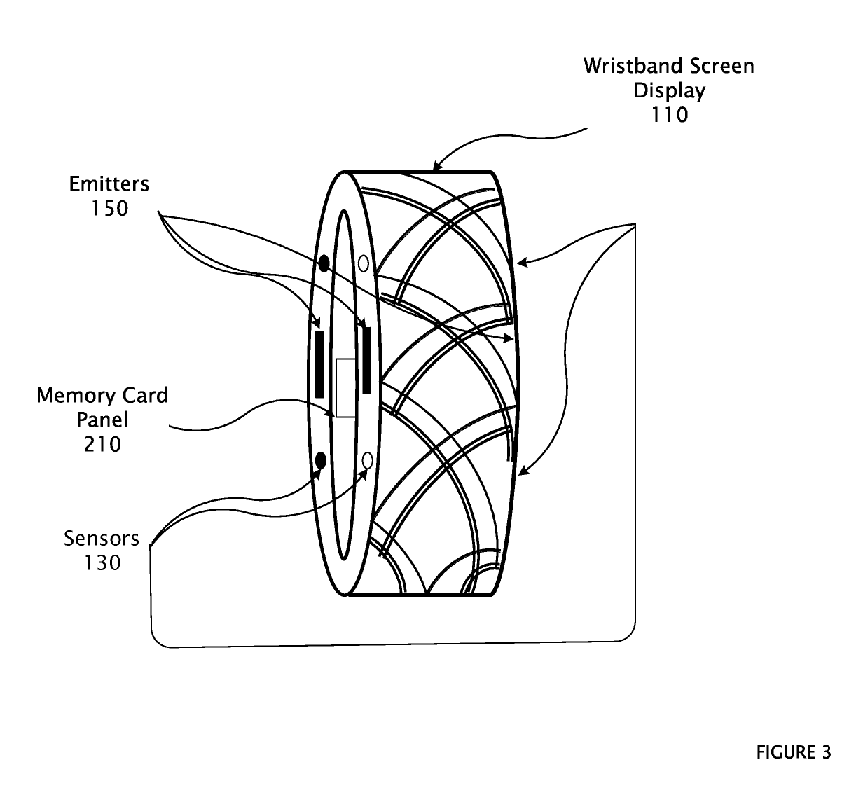

FIG. 3 illustrates a perspective view of Holographic Wristband according to yet another embodiment. In this example, Wristband Screen Display 110 may display designs, patterns, logos or any other images or data, which may be built into the device, downloaded from a third-party source, or generated or personalized by a user, for example.

Sensors 130 may detect, receive, and analyze data such as images, movements, health and environmental conditions, and other data, and communicate that data with Holographic Wristband or any other device. Emitters 150 may project any 2D images, 3D images, and sounds, for example, holographic images. Memory Card Panel 210 may receive any type of data storage device.

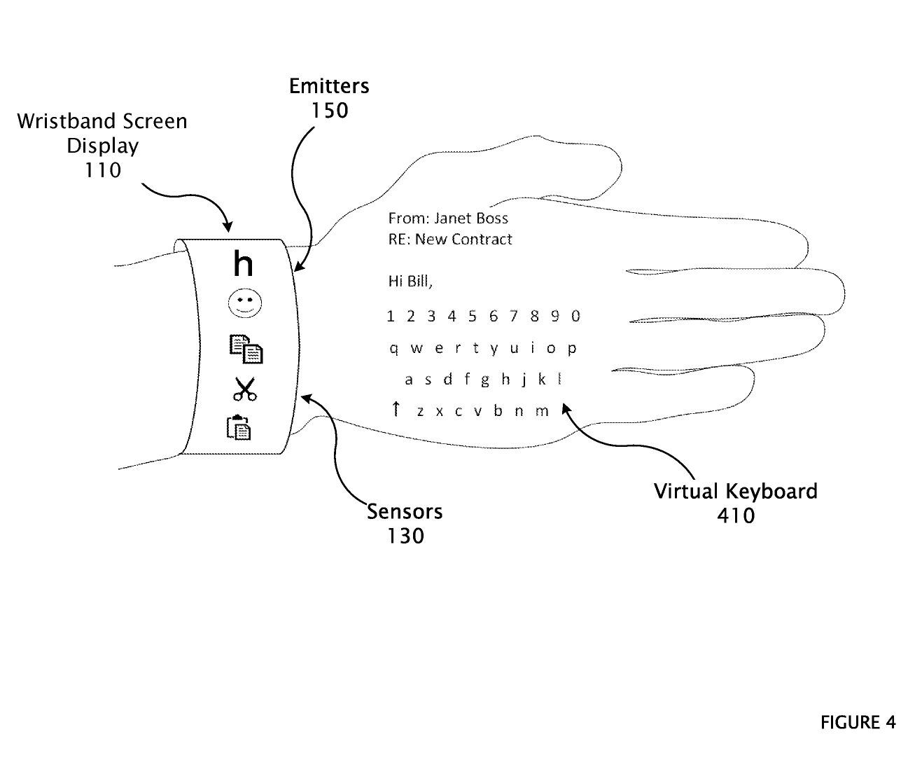

FIG. 4 illustrates a rear view of Holographic Wristband projecting a virtual keyboard, according to one embodiment. In this example, Wristband Screen Display 110 may show various icons related to a holographic projection: emoticons and symbols, copy, cut, and paste, for example. Emitters 150 may project 2D or 3D images such as a Virtual Keyboard 410. Sensors 130 may detect, receive, and analyze finger movements, for example, made by a user utilizing a Virtual Keyboard 410 to carry out a task such as composing, sending an email message, or any other application accepting any entry of characters in any language. Sensors 130 may communicate data collected with Holographic Wristband or any other device. A user may use any surface such as the palm or top of a hand to receive the projected image, or the image may not require a surface.

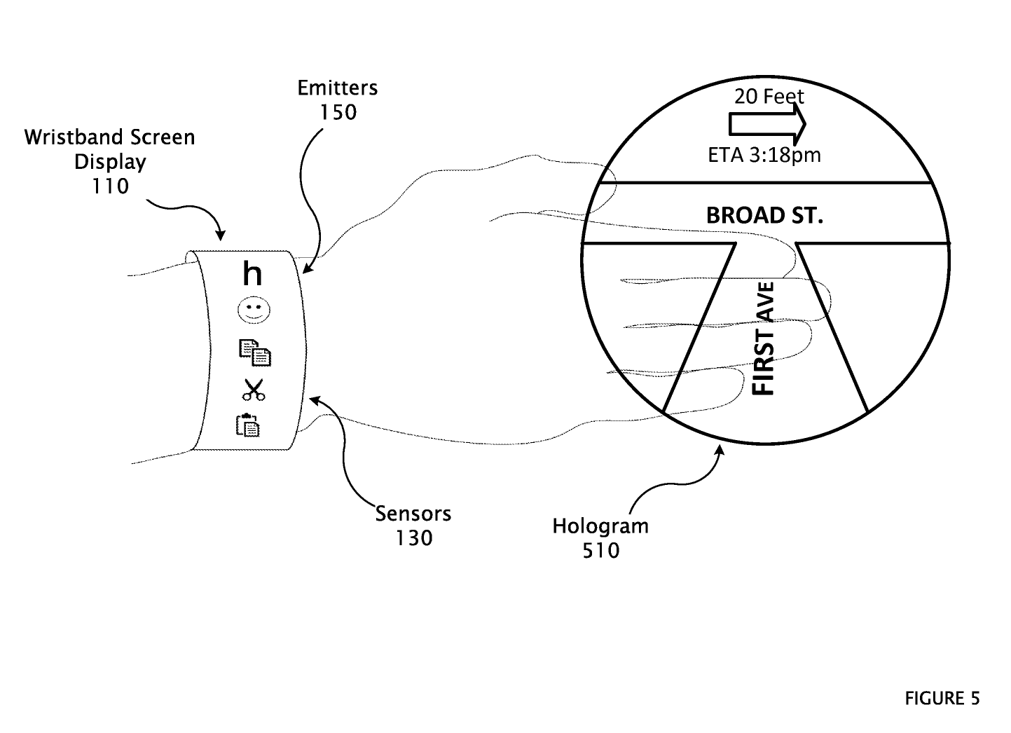

FIG. 5 illustrates a view of Holographic Wristband projecting a holographic image, according to one embodiment. Wristband Screen Display 110 may display various images on its touch-sensitive LED surface. Emitters 150 may project 2D or 3D images such as Hologram 510. In this example, Hologram 510 may comprise an interactive holographic map. A user may access the map using a computer application on the Holographic Wristband, and the map may interact with location-detecting applications such as a global positioning system (GPS). Sensors 130 may detect, receive, and analyze finger movements, made, for example, as the user navigates through Hologram 510. The user may use any surface such as the palm or top of a hand to receive the projected Hologram 510, or the image may not require a surface.

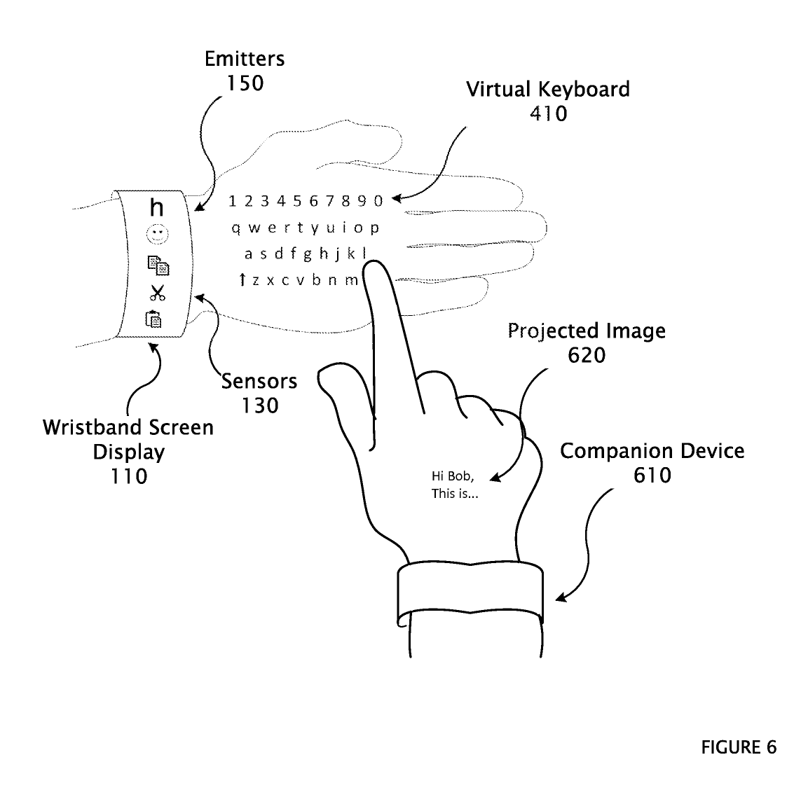

FIG. 6 illustrates a view of Holographic Wristband functioning with a Companion Device 610, according to one embodiment. Wristband Screen Display 110 may show various images and icons on its touch-sensitive LED screen. Emitters 150 may project 2D or 3D images such as a Virtual Keyboard 410. Sensors 130 may detect, receive, and analyze finger movements, for example, made by a user utilizing a Virtual Keyboard 410 and communicate data collected with Holographic Wristband or any other device such as Companion Device 610. In this example, Holographic Device may communicate, share data, and delegate tasks with Companion Device 610. For example, Companion Device 610 may provide additional storage and distribute processing loads. In this example, a user may use a Holographic Wristband to generate a virtual keyboard and use Companion Device 610 to create Projected Image 620, such as an email message viewer, for example.

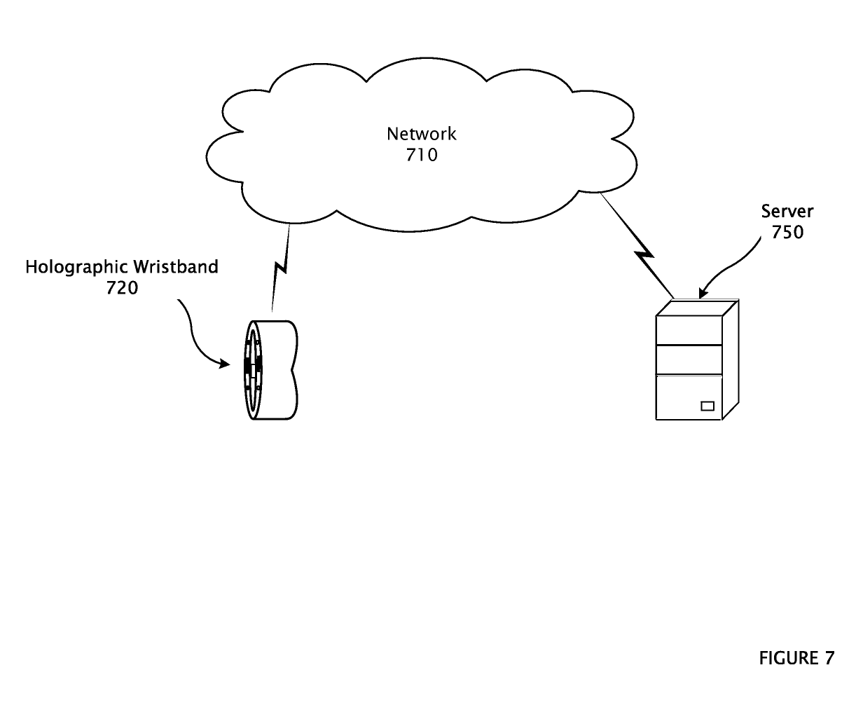

FIG. 7 is a block diagram illustrating an example of a system capable of supporting a Holographic Wristband method, according to one embodiment. Network 710 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 710 may comprise Ethernet connectivity. In another embodiment, Network 710 may comprise fiber optic connections.

Holographic Wristband 720 may have location-based services, for example, GPS, cell phone tower triangulation capability, or accelerometers, and may have network capabilities to communicate with Server 750. Server 750 may include one or more computers, and may serve several roles. Server 750 may be conventionally constructed or may be of a special purpose design for processing data obtained from a Holographic Wristband. One skilled in the art will recognize that Server 750 may be of many different designs and may have different capabilities.

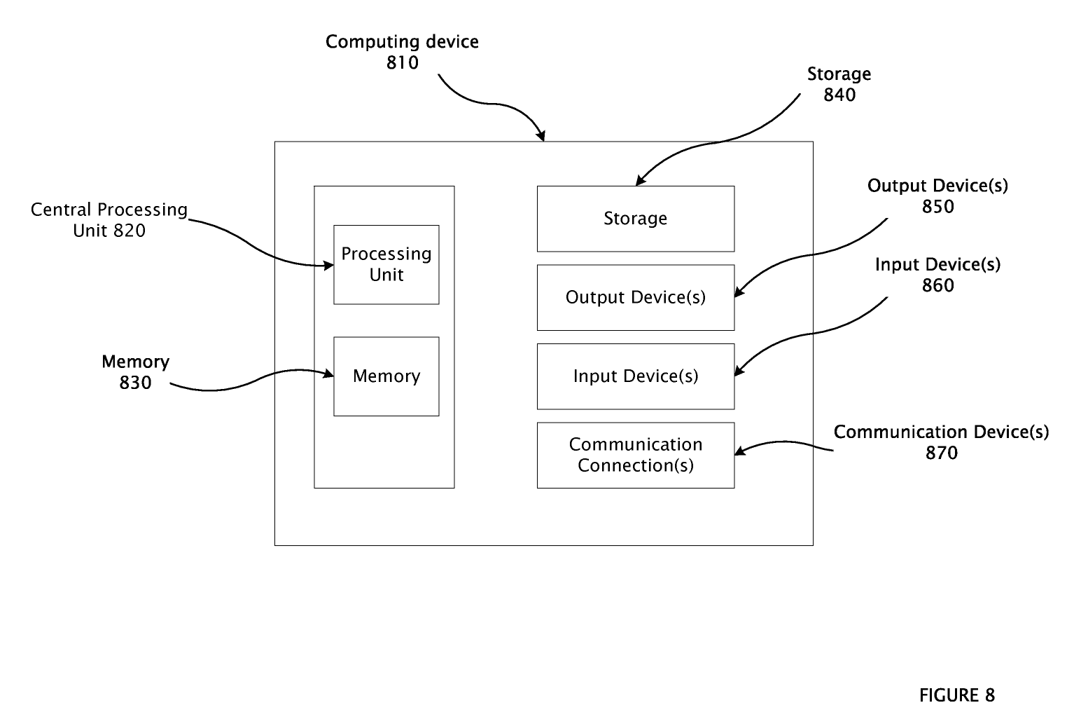

FIG. 8 is a component diagram of a computing device to which a Holographic Wristband process may be applied according to one embodiment. The Computing Device 810 can be utilized to implement one or more computing devices, computer processes, or software modules described herein, including, for example, but not limited to a mobile device. In one example, the Computing Device 810 can be used to process calculations, execute instructions, and receive and transmit digital signals. In another example, the Computing Device 810 can be utilized to process calculations, execute instructions, receive and transmit digital signals, receive and transmit search queries and hypertext, and compile computer code suitable for a mobile device. The Computing Device 810 can be any general or special purpose computer now known or to become known capable of performing the steps and/or performing the functions described herein, either in software, hardware, firmware, or a combination thereof.

In its most basic configuration, Computing Device 810 typically includes at least one Central Processing Unit (CPU) 820 and Memory 830. Depending on the exact configuration and type of Computing Device 810, Memory 830 may be volatile (such as RAM), non-volatile (such as ROM, flash memory, etc.) or some combination of the two. Additionally, Computing Device 810 may also have additional features/functionality. For example, Computing Device 810 may include multiple CPUs. The described methods may be executed in any manner by any processing unit in Computing Device 810. For example, the described process may be executed by multiple CPUs in parallel.

Computing Device 810 may also include additional storage (removable or non-removable) including, but not limited to, magnetic or optical disks or tape. Such additional storage is illustrated in FIG. 4 by Storage 840. Computer-readable storage media include volatile and nonvolatile, removable and non-removable media implemented in any method or technology for storage of information such as computer-readable instructions, data structures, program modules or other data. Memory 830 and Storage 840 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 810. Any such computer-readable storage media may be part of Computing Device 810. But computer-readable storage media do not include transient signals.

Computing Device 810 may also contain Communications Device(s) 870 that allow the device to communicate with other devices. Communications Device(s) 870 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 810 may also have Input Device(s) 860 such as keyboard, mouse, pen, voice input device, touch input device, etc. Output Device(s) 850 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A wristband, comprising:
a processor;
a sensor; and
a projection display.

2. The wristband of claim 1, wherein the projection display projects an image of a keyboard.

3. The wristband of claim 1, wherein the projection display is a holographic projection display.

4. The wristband of claim 1, wherein the sensor is capable of detecting movement.

5. The wristband of claim 1, wherein the sensor is capable of receiving wireless communications.

6. The wristband of claim 1, wherein the sensor is capable of detecting the location of an object in 2D or 3D space.

7. The wristband of claim 1, wherein the processor is capable of analyzing detected movement and received data.

8. The wristband of claim 1, wherein a user can interact with projected display.

9. The wristband of claim 1, further comprising a watch.

10. The wristband of claim 1, further comprising a phone.

11. The wristband of claim 1, further comprising a communications module to interact with a companion device.

12. The wristband of claim 1, further comprising a magnetic clasp.

13. A system comprising:
a processor;
a memory operably coupled to the processor;
at least one sensor;
a projection display; and
components disposed in the memory, the components being operable by the processor, comprising:
a data receiving component, configured to receive data from the sensor; and
a data processing component, configured to process the data received to prepare it for display.

14. Computer-readable storage media containing instructions thereon which, when executed by a processor, perform a method comprising:
sensing, and
projecting data.
